(19) United States
(12) Patent Application Publication
(10) Pub. No.: US 2014/0180932 A1
(43) Pub. Date: Jun. 26, 2014

(54) PROCESS FOR DETERMINING REASONABLENESS OF VALUE CONCLUSION

(71) Applicants: MARK LEIGH STOCKTON, YOUNGSVILLE, NM (US); ROBERT F. HAUSMAN, CERRILLOS, NM (US)

(72) Inventors: MARK LEIGH STOCKTON, YOUNGSVILLE, NM (US); ROBERT F. HAUSMAN, CERRILLOS, NM (US)

(21) Appl. No.: 14/135,402

(22) Filed: Dec. 19, 2013

Related U.S. Application Data
(60) Provisional application No. 61/739,934, filed on Dec. 20, 2012.

(51) Int. Cl. G06Q 30/02

(52) U.S. Cl. CPC G06Q 30/0278
USPC 705/306

(57) ABSTRACT

Some embodiments of the invention include a method for determining the reasonableness of a valuation conclusion made for an object. In some embodiments, the method includes producing independent value estimates based on applying analytics to information within databases and producing additional independent value estimates derived from the applying the analytics to the information. The method includes comparing the additional information with the value conclusion. The method of some embodiments also includes generating a reasonableness report based on the comparisons.

### CLAIM OF BENEFIT TO PRIOR APPLICATION

This application claims benefit to U.S. Provisional Patent Application 61/739,934, entitled “Process for Determining Reasonableness of Value Conclusion,” filed Dec. 20, 2012. The U.S. Provisional Patent Application 61/739,934 is incorporated herein by reference.

### BACKGROUND

Embodiments of the invention described in this specification relate generally to valuations of appraised objects, and more particularly, to methods for identifying the reasonableness of valuations of appraised property.

A variety of information is used to in the normal course of many activities to perform valuations. For example, sellers of antique furniture estimate the value of each furniture item offered for sale. Different classes of activities often require different types of valuations, and therefore, different information is used in performing these valuations for the different classes of activities. For example, buyers of rare automobiles use valuation data that is different from the valuation data used by buyers of common automobiles. Furthermore, different valuation data sources are often used within even the same activity class. As buyers, sellers, lenders, investors, reviewers, and others may each rely on different information sources in order to determine valuation of various items, it is difficult to compare different value conclusions. To resolve this issue, the accuracy of many valuations is checked. This is problematic because different valuations of the same object may be equally accurate given their respective sources of value information. There is currently no industry requirement that value conclusions be tested for reasonableness and no automated means of achieving this has been heretofore developed. Thus, anyone interested in comparing different value conclusions for the same object will not necessarily understand whether one accurate value conclusion is more reasonable than another equally accurate value conclusion.

### BRIEF SUMMARY

Some embodiments of the invention include a method for determining the reasonableness of a value conclusion made for an object. In some embodiments, the method includes producing independent value estimates based on applying analytics to information within databases and producing additional independent value estimates derived from applying the analytics to the information. The method includes comparing the additional information with the value conclusion.

In some embodiments, the value conclusion is an appraised value of property. In some embodiments, the method determines the reasonableness of the appraised value of the property based on independent appraised values of the property.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having thus described the invention in general terms, reference is now be made to the accompanying drawings, which are not necessarily drawn to scale, and wherein:

FIG. 1 conceptually illustrates a process of some embodiments for determining the reasonableness of a value conclusion.

FIG. 2 conceptually illustrates another similar process of some embodiments for determining the reasonableness of a value conclusion.

FIG. 3 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments of the invention include a method for determining the reasonableness of a value conclusion made for an object. In some embodiments, the method includes producing independent value estimates based on applying analytics to information within databases and producing additional independent value estimates derived from applying the analytics to the information. The method includes comparing the additional information with the value conclusion.

In some embodiments, the value conclusion is an appraised value of property. In some embodiments, the method determines the reasonableness of the appraised value of the property based on independent appraised values of the property.

In some embodiments, the value conclusion is based on an independent appraisal of the property by the valuation professional. The valuation professional may use one or more analytical sources to derive the value conclusion or may use none at all. For example, the valuation professional may use average sale prices of recently sold nearby properties to determine the price per square foot of a property he is preparing for sale. As different analytical sources evaluate data information differently, the value conclusion made for the object is evaluated. A level of credibility is thereby associated with the value conclusion based on the evaluation. For instance, a particular value conclusion is dubious if it is based only on an average sale price without regard to the type of property sold (e.g., a commercial property valued at $2,000,000 is unreasonably low when two nearby commercial properties of similar characteristics both recently sold for $2,950,000, but the value conclusion also considered the recent sale for $100,000 of a nearby undeveloped plot of land).

Such evaluation has not heretofore been available, and thus, the method of these embodiments allows the valuation professional to determine a level of reasonableness of a particular value conclusion. Thus, when the evaluation is in support of the value conclusion, the valuation professional can confidently provide the value conclusion to different parties. In contrast, when the evaluation does not adequately support of the value conclusion, the valuation professional is provided a chance to perform the valuation again. In this way, the valuation professional is able to try to derive a more reasonable value conclusion to include in a better valuation report.

The method of some embodiments begins when a valuation professional performs a valuation of an object and, based on the valuation, provides a valuation conclusion. In these embodiments, the method includes receiving the valuation conclusion provided by the valuation professional. The method also includes determining whether the valuation conclusion is reasonable.

In some embodiments, when the valuation professional provides the valuation conclusion made for the object, the method includes analyzing the object and forming identifying characteristic data. In some embodiments, the method includes comparing the object identifying characteristic data to data of similar objects to form result value estimates for the object.

The method includes comparing the result value estimates to the value conclusion from the valuation of the object completed by a valuation professional. Based on the comparison of the result value estimates and value conclusion, the method of some embodiments includes preparing a report of the comparison for review by the valuation profession. The method also includes sending the comparison result to the valuation professional to determine how to proceed.

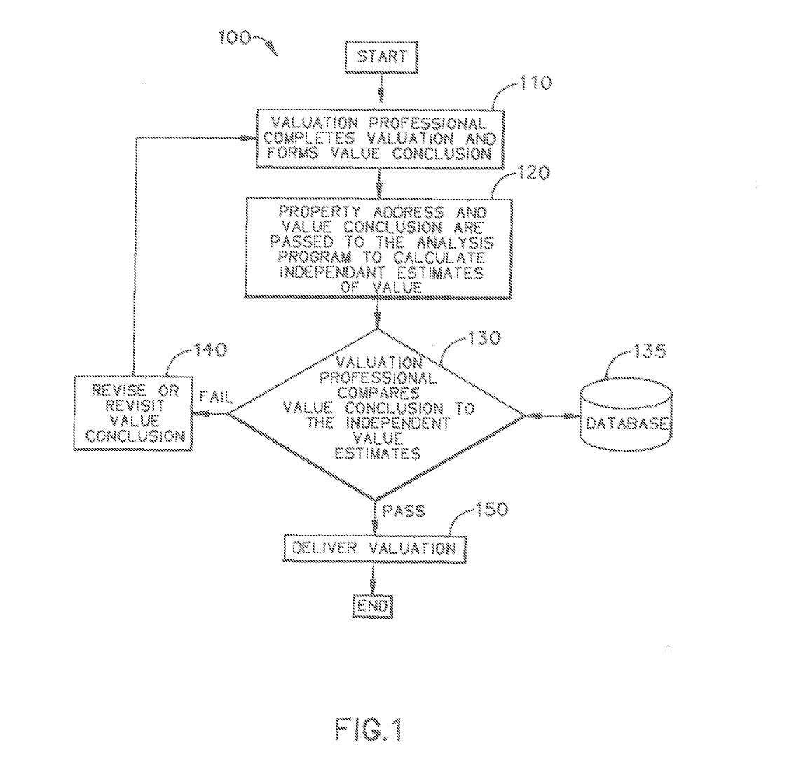

FIG. 1 conceptually illustrates a process of some embodiments for determining the reasonableness of a value conclusion. In some embodiments, the process 100 is performed at least in part by an analysis program running on a computing device. As shown in FIG. 1, the process of some embodiments begins (at 110) when a valuation professional performs a valuation of an object. For example, a property may be appraised to determine an appraised property value. Based on the valuation, the professional forms a value conclusion. For instance, an appraiser may determine a “market value” for a property based on the appraisal.

Next (at 120) the property address and value conclusion is passed to the analysis program to calculate independent estimates of value. In some embodiments, the valuation professional provides the value conclusion upon completion of the valuation, but before delivery (e.g., to a reviewer, a client, a manager, etc.) of the valuation report. In these embodiments, the process receives the value conclusion formed by the valuation professional to determine whether the value conclusion is reasonable.

In some embodiments, the process 100 includes determining (at 130) whether the value conclusion is reasonable by comparing the value conclusion to the independent value estimates. In some embodiments, the process retrieves each of the independent value estimates from a data storage 135. In other embodiments, the independent value estimates are already available to the process for comparing to the value conclusion formed by the valuation professional. For example, the analysis program may keep the independent estimates of value in computer memory after calculating the estimates at step 120 of the process 100.

Regardless of whether the process retrieves the estimates of value from the data storage 135 or in memory, the process will deliver the valuation (at 150) to another valuation professional if the preliminary comparison of the value conclusion to the independent estimates of value is sufficiently reasonable. For example, if the independent estimates of value vary from each other by only 8%, then the value conclusion formed by the valuation professional would be reasonable if, compared to the independent value estimates, it varied by only 5%. Such a reasonable value conclusion could then be sent to a reviewer, manager, etc., who would decide which course of action to take next.

On the other hand, if the value conclusion formed by the valuation professional is 35% higher or lower than the independent estimates, then the process will transition to 140 to revise or revisit the value conclusion. Then the process transitions back to 110 where the valuation professional completes the valuation and forms a new value conclusion, as described above.

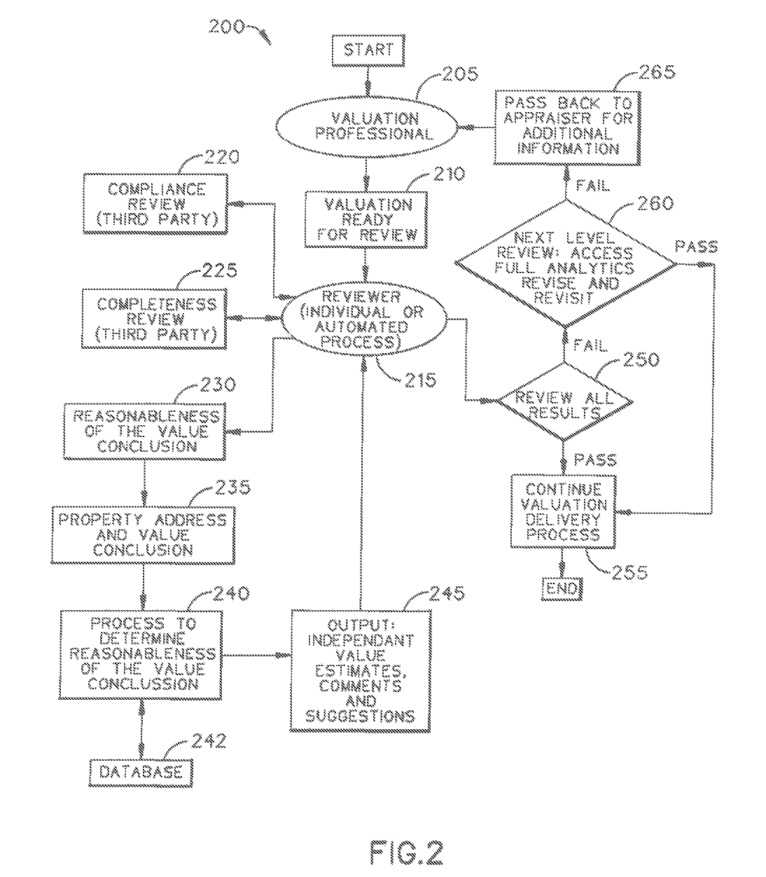

FIG. 2 conceptually illustrates a process of some embodiments for reviewing the reasonableness of a value conclusion. In some embodiments, an analysis program running on a computing device automatically performs the steps of this process 200. The review process 200 starts when a valuation professional 205 provides a valuation that is ready for review (at 210). The review process 200 allows review of the valuation before delivery to another party, such as a client. In some embodiments, the reviewer 215 of the review process 200 is another valuation professional, such as an appraisal reviewer or a manager. In some embodiments, the valuation is ready for review after delivery (e.g., delivery at step 150 of FIG. 1) of a value conclusion that has been compared to independent value estimates and determined to be reasonable.

In some other embodiments, the reviewer 215 is an automated process of the analysis program that runs on a computing device. The process 200 in these embodiments receives the value conclusion electronically in a digital format. The comparison is then automatically performed by a computer system capable of performing independent analytics on the value conclusion based on the characteristics of the property and a database of information pertaining to other similar properties. For example, if a piece of fine art is being valued, a database of other fine art items can be automatically be accessed by the computer system to perform the comparison.

When the process 200 proceeds to the reviewing step 215, the reviewer determines the next course of action to take. The reviewer in some embodiments can have a third party perform reviews to check one or more of (i) whether the submitted valuation complies with a set of compliance rules (at 220) and (ii) whether the submitted valuation is complete (at 225). Regardless of whether or not the reviewer has a third party perform any reviews, in some embodiments, the reviewer can check either or both of the reasonableness of the value conclusion (at 230) delivered in the valuation, and whether to deliver a report with no further action (at 250).

In some embodiments, the third party compliance and completeness reviews (at 220 and 225) are performed by one or more third parties at the request of the reviewer. In some of these embodiments, each third party provides a result set of information detailing the results of the respective review. In some embodiments, the process 200 provides the result sets to the automated process for analysis. For example, the valuation may be sent to a third party to check whether the valuation is based on a value conclusion derived by appraisal methods that comply with a set of appraisal rules, and the results of the third party review may be input into a program and provided as a data set to the analysis program.

When the next course of action is to check the reasonableness of the value conclusion (at 230), the review process 200 of some embodiments provides (at 235) the property address and value conclusion to a sub-process that determines (at 240) the reasonableness of the value conclusion. In some embodiments, the process determines the reasonableness of the value conclusion by comparing the result value estimates to at least one of a revised value conclusion recalculated by the reviewer and a revised value conclusion based on another action by the reviewer. In some embodiments, the reviewer performs independent analytics to compare the property to similar properties to form result value estimates for the property. The results of the independent analytics are then compared to the value conclusion. In some embodiments, the process retrieves similar properties from a database 242 in order to form the result value estimates.

The independent analytics are performed by the process 200 of some embodiments in order to generate output (e.g., a report) that includes a comparison between the value conclusion and each of the independent value estimates derived by the independent analytics. The report may include a reasonableness score, comments, and/or suggestions. For instance, suggestions may be provided when the value conclusion is not sufficiently supported by the analytics. For example, there might be logic that informs the valuation professional that the value conclusion is not supported by any of the estimates from the independent analytics (e.g., no estimate within +/−10% of value conclusion). In that case, a recommendation or suggestion may be provided to cure or alleviate the problem. The process 200 then transitions back to the reviewing step 215, for the reviewer to determine the next course of action.

When the next course of action is to deliver a report with no further action, the reviewer may determine whether the submitted valuation passes or fails. To do so, the process 200 determines (at 250) whether all of the results from any reviews pass. If any one review does not pass, then the process 200 determines that it fails, and transitions to 260, which is described further below. On the other hand, if the reviews all pass, the process 200 transitions to 255, which is described further below. For instance, the process 200 may be instructed, from a third party that reviewed compliance rules, that the valuation fails at least one compliance rule. Alternatively, the reviewer could determine whether analytics used to derive the value conclusion are sufficient to generate accurate results, and then determine that it passes or fails.

Alternatively, or in conjunction with one or both of the compliance and completeness reviews, the reviewer in some embodiments determines whether the valuation passes or fails on review. When the valuation passes, the process 200 continues to deliver (at 255) the valuation to the end party. For instance, the appraisal reviewer may send the valuation report to the client. Then the process 200 ends. On the other hand, when the valuation fails, the process 200 determines (at 260) the next level review process for the valuation. In some embodiments, the process accesses (at 260) a full set of analytics in order to revise the value conclusion and revisit the valuation. When the next level review results in a sufficiently complete valuation report, the process 200 continues to deliver (at 255) the valuation to the other party (e.g., client), which was described above. However, when the next level review process fails, the process passes (at 265) the valuation back to the appraiser for additional information. The process then transitions to 205 to start over.

In some embodiments, the generated report allows the valuation professional to determine how to proceed. The report can be provided in any of several formats including digital copy, hard copy, or another copy format. The report may be electronically sent to the valuation professional immediately upon generating the report. In this way, the valuation professional is provided nearly instantaneous comments and suggests of the value conclusions provided for review.

In some cases, the valuation professional can choose the course of action to follow based on the report. For example, the valuation professional may want to ensure that any value conclusion he makes at an auction is within an industry standard, and thus, he can provide value conclusions of different antiques to and receive reports from the computer system during the actual auction. The valuation professional can also quickly determine whether a price for an auction item is a reasonable price based on a value conclusion, and if so, can then make a bid on the item. Thus, the ability to quickly determine the reasonableness of a value conclusion is a key benefit of the process because it allows the professional to quickly determine the next course of action.

While valuation professionals can contemporaneously gauge valuations with these processes, in some embodiments, the processes can be used by reviewers and managers of valuation professionals. For example, a manager can determine if the value conclusions of a valuation professional are improving over time by tracking the reasonableness of the conclusions. Also, many reviews are performed by buyers, sellers, lenders, investors and others at various stages throughout the lifecycle of any valuation.

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

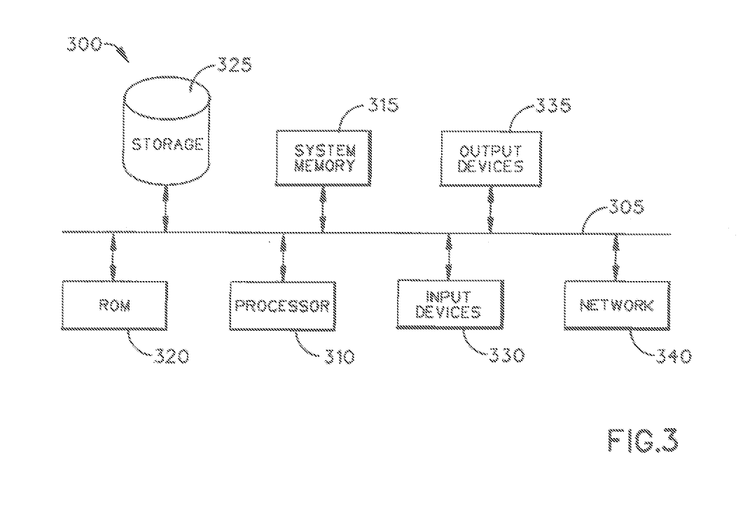

FIG. 3 conceptually illustrates an electronic system 300 with which some embodiments of the invention are implemented. The electronic system 300 may be a computer, phone, PDA, or any other sort of electronic device. Such an electronic system includes various types of computer readable media and interfaces for various other types of computer readable media. Electronic system 300 includes a bus 305, processing unit(s) 310, a system memory 315, a read-only 320, a permanent storage device 325, input devices 330, output devices 335, and a network 340.

The bus 305 collectively represents all system, peripheral, and chipset buses that communicatively connect the numerous internal devices of the electronic system 300. For instance, the bus 305 communicatively connects the processing unit(s) 310 with the read-only 320, the system memory 315, and the permanent storage device 325.

From these various memory units, the processing unit(s) 310 retrieves instructions to execute and data to process in order to execute the processes of the invention. The processing unit(s) may be a single processor or a multi-core processor in different embodiments.

The read-only-memory (ROM) 320 stores static data and instructions that are needed by the processing unit(s) 310 and other modules of the electronic system. The permanent storage device 325, on the other hand, is a read-and-write memory device. This device is a non-volatile memory unit that stores instructions and data even when the electronic system 300 is off. Some embodiments of the invention use a mass-storage device (such as a magnetic or optical disk and its corresponding disk drive) as the permanent storage device 325.

Other embodiments use a removable storage device (such as a floppy disk or a flash drive) as the permanent storage device 325. Like the permanent storage device 325, the system memory 315 is a read-and-write memory device. However, unlike storage device 325, the system memory 315 is a volatile read-and-write memory, such as a random access memory. The system memory 315 stores some of the instructions and data that the processor needs at runtime. In some embodiments, the invention's processes are stored in the system memory 315, the permanent storage device 325, and/or the read-only 320. For example, the various memory units include instructions for processing appearance alterations of displayable characters in accordance with some embodiments. From these various memory units, the processing unit(s) 310 retrieves instructions to execute and data to process in order to execute the processes of some embodiments.

The bus 305 also connects to the input and output devices 330 and 335. The input devices enable the user to communicate information and select commands to the electronic system. The input devices 330 include alphanumeric keyboards and pointing devices (also called “cursor control devices”). The output devices 335 display images generated by the electronic system 300. The output devices 335 include printers and display devices, such as cathode ray tubes (CRT) or liquid crystal displays (LCD). Some embodiments include devices such as a touchscreen that functions as both input and output devices.

Finally, as shown in FIG. 3, bus 305 also couples electronic system 300 to a network 340 through a network adapter (not shown). In this manner, the computer can be a part of a network of computers (such as a local area network (“LAN”), a wide area network (“WAN”), or an Intranet), or a network of networks (such as the Internet). Any or all components of electronic system 300 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes and logic flows may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For example, processes are conceptually illustrated in FIGS. 1 and 2. The specific operations of these processes may not be performed in the exact order shown and described. Specific operations may not be performed in one continuous series of operations, and different specific operations may be performed in different embodiments. Furthermore, the processes could be implemented using several sub-processes, or as part of larger macro processes. Thus, one of ordinary skill in the art would understand that the invention is not to be limited by the foregoing illustrative details and examples, but rather is to be defined by the appended claims.

I claim:

1. A non-transitory computer readable medium storing a program which when executed by at least one processing unit of a computing device automatically determines whether a valuation of a particular property is reasonable, said program comprising sets of instructions for:
receiving a valuation of the particular property, said valuation comprising a value conclusion derived from an appraisal of the particular property;
producing a set of independent value estimates based on comparing the particular property with a set of other properties;
comparing the independent value estimates to the value conclusion; and
generating a report that indicates the reasonableness of the valuation, wherein (i) when the value conclusion is within a threshold value of each of the independent value estimates, the valuation of the particular property is reasonable, and (ii) when the value conclusion is not within a threshold value of at least one of the independent value estimates, the valuation of the particular property is not reasonable.

2. The non-transitory computer readable medium of claim 1, wherein the generated report further indicates whether the valuation passes one or more reviews outside of the reasonableness of the valuation.

3. The non-transitory computer readable medium of claim 2, wherein the generated report further indicates whether the valuation passes a compliance review.

4. The non-transitory computer readable medium of claim 2, wherein the generated report further indicates whether the valuation passes a completeness review.

5. The non-transitory computer readable medium of claim 1, wherein the set of instructions for generating the report comprises sets of instructions for:
delivering the report when the generated report indicates that the valuation is reasonable; and
delaying delivery of the report to perform an enhanced review of the valuation when the generated report indicates that the valuation is not reasonable.

6. The non-transitory computer readable medium of claim 5, wherein the set of instructions for performing the enhanced review comprises sets of instructions for:
accessing a full set of analytics;
revising the value conclusion; and
revisiting the valuation based on the revised value conclusion.

7. A non-transitory computer readable medium storing a program which when executed by at least one processing unit of a computing device determines whether a valuation of a particular property is reasonable, said program comprising sets of instructions for:
receiving an address of a particular property;
receiving a value conclusion of the particular property;
deriving a set of independent value estimates for a set of comparable properties;
comparing the value conclusion of the particular property to the set of independent value estimates;
determining whether the value conclusion of the particular property is reasonable based on the comparison; and
delivering the valuation when the value conclusion is reasonable.

8. The non-transitory computer readable medium of claim 7, wherein the set of instructions for deriving the set of independent value estimates comprises a set of instructions for retrieving a set of property information from a database for each property in the set of comparable properties.

9. The non-transitory computer readable medium of claim 8, wherein the set of instructions for retrieving the set of property information from the database comprises sets of instructions for:
identifying a set of addresses that are near the address of the particular property; and
associating each identified address with a property.

10. The non-transitory computer readable medium of claim 7 further comprising sets of instructions for:
revising the value conclusion when the value conclusion is not reasonable; and
revisiting the valuation based on the revised value conclusion.
